(19) United States
(12) Patent Application Publication
(10) Pub. No.: US 2007/0225923 A1
(43) Pub. Date: Sep. 27, 2007

(54) OPTIMIZING ENERGY PRODUCTION OF A LANDFILL GAS EXTRACTION SYSTEM

(76) Inventor: Jamie Tooley, Yucaipa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/566,659

(22) Filed: Dec. 4, 2006

Related U.S. Application Data
(60) Provisional application No. 60/786,485, filed on Mar. 27, 2006.

(51) Int. Cl. G01F 1/00

(52) U.S. Cl. 702/47

(57) ABSTRACT

A computing system determines adjustments for each of a plurality of wellheads in a gas extraction system in order to increase a total energy production of the gas extraction system to at least an expected total energy production. The computing system determines preliminary adjustments for each of the wellheads and then determines further adjustments to certain of the wellheads based at least partly on a current energy production of respective wellheads, data regarding historical energy production of respective wellheads, and an affect the preliminary adjustment for a respective wellhead would have on the total energy production of the gas extraction system.

### RELATED APPLICATIONS

This application claims the benefit of U.S. Provisional Patent Application No. 60/786,485, filed Mar. 27, 2006, which is hereby incorporated by reference in its entirety herein.

### BACKGROUND OF THE INVENTION

1. Field of the Invention

The invention relates to landfill gas control and monitoring systems and, more particularly, to systems and methods for optimizing production of landfill gas.

2. Description of the Related Art

Landfills are disposal sites for the deposit of waste onto or into land, such as underground. One type of landfill is a municipal solid waste (MSW) landfill that receives household waste or waste from other sources having similar composition as household waste. Much of the waste placed in MSW landfills, for example, includes waste that decomposes at the landfill. When decomposable waste is placed into a landfill, the waste may be at least partially surrounded by air from the surrounding atmosphere. Through a natural process of bacterial decomposition, the oxygen from the air is consumed and an anaerobic, i.e., oxygen free, environment is created within the landfill. Additionally, further waste may be positioned above existing waste, further restricting air flow to the buried waste.

An anaerobic environment is one of several conditions necessary for the formation of methane, which may be extracted from the landfill by a landfill gas (“LFG”) extraction system. Extracted methane gas, or other LFGs, may be used as fuel for electrical generation. Compared to other fossil fuels, burning methane produces less carbon dioxide for each unit of heat released. In many municipalities, methane is piped into homes for domestic heating and cooking purposes. Methane may also be used in industrial chemical processes and may be transported in liquid or refrigerated liquid form.

If oxygen is introduced into the landfill, those portions into which the oxygen is present are returned to an aerobic, i.e., oxygen present, state, and the methane producing bacteria population is reduced or eliminated. If the bacteria population is reduced, some time must pass before the productive capacity is returned to normal.

A LFG extraction system typically comprises one or more wellheads that are installed in the waste at the landfill and remove the LFG from the landfill. The wellheads may be connected by piping and coupled to a vacuum source that moves LFG from the wellheads to a storage container for further processing, destruction, and/or transport. As those of skill in the art will recognize, production of methane from a particular wellhead may be increased by adjusting the wellhead so that vacuum applied to the wellhead is increased. While a greater amount of methane, and a corresponding energy production, may be realized from the wellhead over the short term by maximizing vacuum, this may ultimately lead to diminishing returns. The diminishing returns results from what may generally be referred to as “overpulling” the wellhead. Overpulling may be seen in stages as the carbon dioxide and oxygen levels increase and the methane content of the LFG decreases. This is a result of a portion of the landfill, usually at the surface, being driven aerobic killing off at least a portion of the methane producing bacteria. This change of a portion of the landfill to an aerobic state reduces the methane producing capacity of the landfill. In addition, if vacuum to a particular wellhead is maximized by opening a flow control valve (or simply “flow valve”), for example, vacuum to the remaining wellheads in the landfill may be decreased. Thus, although some of the remaining wellheads may currently be producing a higher concentration of methane, maximum output from those higher concentration wellheads may not be realized due to the use of vacuum by the lower producing wellheads. In this unbalanced configuration, methane production for the LFG system may not be maximized. Thus, as those of skill in the art recognize, adjustment of flow characteristics of a particular wellhead may have an unintended affect on methane production of the entire LFG system. Accordingly, improved systems and methods for adjusting wellhead parameters in order to increase energy production at individual wellheads as well as increase a total energy production of the overall LFG system are desired.

### SUMMARY OF THE INVENTION

In one embodiment, a method of optimizing energy production of a landfill gas extraction system positioned at a landfill site, the landfill gas extraction system comprising a plurality of wellheads positioned around the landfill configured to extract landfill gas from the landfill, wherein each of the wellheads comprises a flow valve configured to control an amount of flow through the wellhead into the landfill gas extraction system, the method comprises (a) receiving data regarding characteristics of at least some of the wellheads, (b) determining adjustments to flow valves of at least some of the wellheads in order to optimize energy production at the wellheads, and (c) determining further adjustments to the flow valves of at least some of the wellheads in order to optimize a total energy production of the landfill gas extraction system, wherein the further adjustments indicate that flow to certain wellheads should be decreased below levels indicated by the determined adjustments and flow to other wellheads should be further increased above levels indicated by the determined adjustments.

In another embodiment, a system for optimizing energy production of a landfill gas extraction system positioned at a landfill site, the landfill gas extraction system comprising a plurality of wellheads positioned around the landfill configured to extract landfill gas from the landfill, wherein each of the wellheads comprises a flow valve configured to control an amount of landfill gas that flows through the respective wellhead into the landfill gas extraction system, the method comprises means for receiving data regarding characteristics of at least some of the wellheads, means for determining adjustments to flow valves of at least some of the wellheads in order to optimize energy production at the wellheads, and means for determining further adjustments to the flow valves of at least some of the wellheads in order to optimize a total energy production of the landfill gas extraction system, wherein the further adjustments indicate that flow to certain wellheads should be decreased and flow to other wellheads should be further increased.

In another embodiment, a computer system for determining recommended adjustments to flow rates of at last some of a plurality of wellheads positioned at a landfill, the system comprises a data collection module adapted to receive data regarding characteristics of the wellheads at the landfill, wherein the characteristics are usable to determine a current energy production for the wellheads, the data collection module also receives historical data for the wellheads, the historical data including historical energy production data and historical flow rate data regarding respective wellheads, and an adjustment recommendation module adapted to determine suggested adjustments to the flow rates of at least some of the wellheads, wherein the suggested adjustments for a respective wellhead is determined based at least partly on the current energy production of the respective wellhead, the historical data for the respective wellhead, and an affect a preliminary suggested adjustment would have on a total energy production of the plurality of wellheads.

In another embodiment, a computing system for determining adjustments for each of a plurality of wellheads in a gas extraction system in order to increase a total energy production of the gas extraction system to at least an expected total energy production, the computing system determining preliminary adjustments for each of the wellheads and then determining further adjustments to certain of the wellheads based at least partly on a current energy production of respective wellheads, data regarding historical energy production of respective wellheads, and an affect the preliminary adjustment for a respective wellhead would have on the total energy production of the gas extraction system.

### BRIEF DESCRIPTION OF THE DRAWINGS

FIG. 1 is a diagram illustrating a landfill with a plurality of wellheads positioned around the landfill.

FIG. 2 is an isometric drawings of an exemplary wellhead.

FIG. 3 is a block diagram of a computing system that may be used calculate wellhead adjustment for optimization of a total energy production of the LFG system of FIG. 1.

FIG. 4 is flowchart illustrating a process of optimizing a total energy production of a LFG system by determining adjustments for wellheads of the LFG system.

FIG. 5 is a flowchart illustrating exemplary characteristics of wellheads that may be acquired, stored, and analyzed in order to determine wellhead adjustments.

FIG. 6 is a flowchart illustrating an exemplary method of determining adjustments for individual wellheads of the LFG system of FIG. 1.

FIG. 7 is a flowchart illustrating exemplary methods for calculating additional wellhead adjustments in order to further optimize a projected total energy production of the LFG system of FIG. 1.

### DETAILED DESCRIPTION OF THE PREFERRED EMBODIMENT

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein.

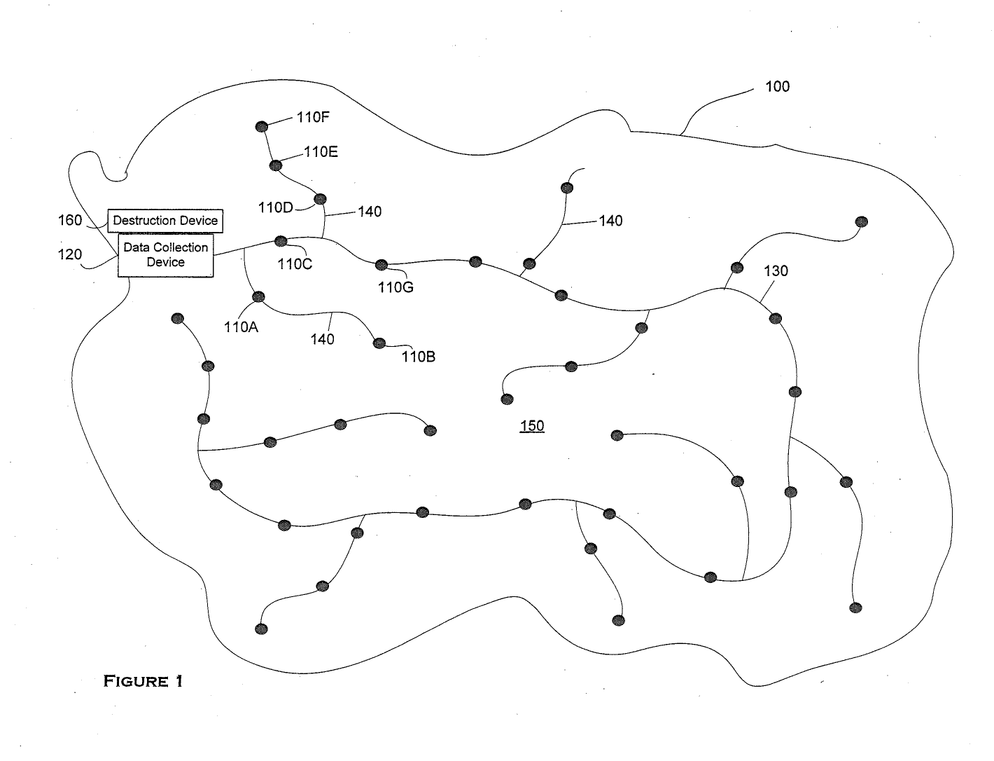

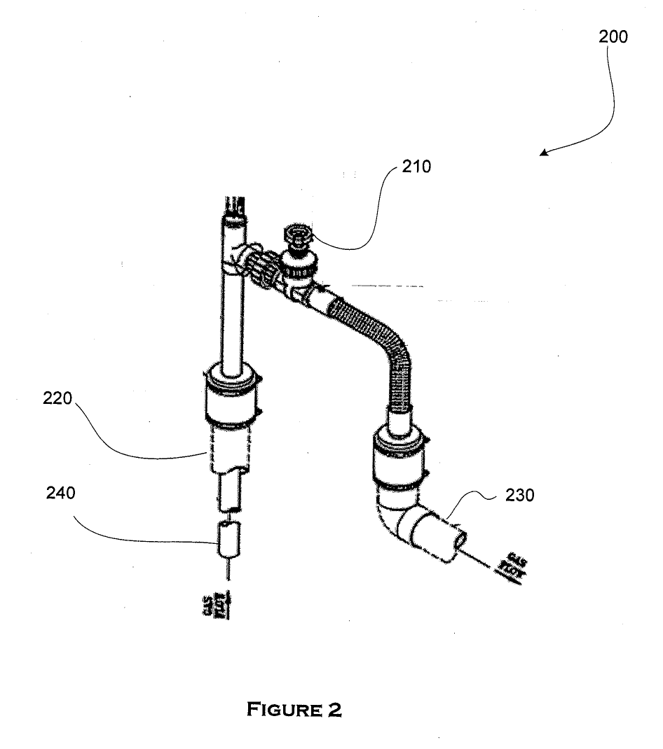

FIG. 1 is a diagram illustrating a landfill 100 with a plurality of wellheads 110 positioned around the landfill 100. In the embodiment of FIG. 1, a landfill gas (“LFG”) control and extraction system 150 (also referred to herein as the “LFG system 150”) is shown arranged on the landfill 100. The LFG system 150 comprises a plurality of wellheads 110 that are coupled to a main header line 130 or to one of a plurality of lateral lines 140, which are in turn connected in the main header line 130. The wellheads 110 are configured to control emission, migration, and/or extraction of gases from the landfill 100. An exemplary wellhead 110 is described in more detail below with reference to FIG. 2.

In the embodiment of FIG. 1, LFG is collected by the wellheads 110 and enters the main header line 130, either directly or via one of the lateral lines 140. The main header line 130 is coupled to a data collection device 120 that is configured to analyze one or more characteristics of the LFG system 150. For example, in one embodiment the data collection device 120 comprises a field server unit, such as the field server units that are sold by LANDTEC in Colton, Calif. In other embodiments, the data collection device 120 may comprise any number of suitable devices that are configured to analyze characteristics of the LFG system 150, including characteristics of the individual wellheads 110 and the LFG that flows through the wellheads, and provide data regarding the LFG system 150 to one or more computing systems and/or storage devices.

In the embodiment of FIG. 1, the main header line 130 is also coupled to a destruction device 160. The destruction device 160 comprises one or more of multiple devices that dispose of the LFG that has been extracted from the landfill 100. In one embodiment, the destruction device 160 comprises a flare that burns the LFG that has been extracted from the landfill 100. In another embodiment, the destruction device 160 comprises a generator that produces electrical energy by burning combustible components in the LFG. In other embodiments, the destruction device 160 may comprise other devices, or combinations of device, that store and/or dispose of the LFG.

In one embodiment, the destruction device 160 also includes a vacuum, or pressure creating device, that is configured to apply a vacuum to the main header line 130 of the LFG system 150. The vacuum created at the destruction device 160 causes suction throughout the main header line 130 and the plurality of lateral lines 140. This suction causes gas surrounding the wellheads 110 that are coupled to the lines 130, 140 to move towards the destruction device 160 and the data collection device 120.

FIG. 2 is an isometric drawings of an exemplary wellheads 200. The exemplary wellhead 200 may be positioned at least partially underground in order to receive and control the flow of gas from a landfill. In one embodiment, some or all of the wellheads 110 of FIG. 1 comprise wellheads similar to exemplary wellhead 200. In other embodiment, additional types of wellheads, that may be configured in various alternative configurations, may also be used in conjunction with the systems and methods described herein.

The wellhead 200 includes a measurement tube 240 that is positioned in the landfill and collects LFG through one or more openings in a well casing 220. In one embodiment the well casing 220 extends about 100 feet into the surface of the landfill 100. In some embodiments, the well casing 220 is inserted into a channel that has been drilled in the landfill 100, and the well casing 220 is surrounded by gravel, or other material that is pervious to gas. In one embodiment, the portion of the well casing 220 that extends into the landfill 100 includes multiple slats that allow gas to enter into the well casing 220. In other embodiments, the well casing 220 may be inserted to various other depths in the landfill 100, such as 20 feet, 50 feet, or 200 feet, for example.

In the embodiment of FIG. 2, the measurement tube 240 is coupled to a flow control valve 210, or simply “flow valve 210,” that controls a level of vacuum that is applied to the measurement tube 240. The flow valve 210 is also coupled to piping 230 that couples the wellhead 110 with out wellheads 110 and with the data collection device 120. In one embodiment, the piping 230 comprises a portion of either the main header line 130 or one of the lateral lines 140 (FIG. 1).

As illustrated in FIG. 2, a number of fittings and a flexible hose segment may be used to couple the flow valve 210 of the wellhead 200 to the piping 230. Those of skill in the art will recognize that other mechanisms for coupling the flow valve 210 to the piping 230 are possible. The systems and methods described herein may advantageously be used in conjunction with any suitable wellhead that is coupled to the main header line 130.

In the embodiment of FIG. 2, the flow valve 210 may be manually adjusted in order to adjust flow rate from the measurement tube 240 that enters the piping 230 and, thus, the amount of flow that is dispersed from the wellhead 200. Thus, by adjusting the flow valve 210, the amount of methane, and a corresponding energy production, of the wellhead 200 may be increased. However, increasing flow of the wellhead 200 may affect the vacuum at other wellheads that are also coupled to the piping 230, such as by reducing vacuum at the other wellheads and thereby potentially decreasing a total energy production of the LFG system.

As discussed above, the exemplary wellhead 200 may be used to control flow of LFG from a landfill into a piping system, such as the main header line 130 and lateral lines 140 of FIG. 1. The quality and quantity of LFG extracted from the landfill 100 can indicate the overall decomposition rate and “health” of the methane producing organisms in the landfill 100. Thus, if a wellhead 110 in the LFG system 150 draws too much vacuum, air from the surface of the landfill 100 can be pulled into the landfill 100, potentially reducing the methane producing organisms. This may lead to reduced decomposition until the proper oxygen free environment is re-established. In addition to decreased methane production, introduction of air into LFG system 150 creates an increased risk of sub-surface fires within the LFG system 150.

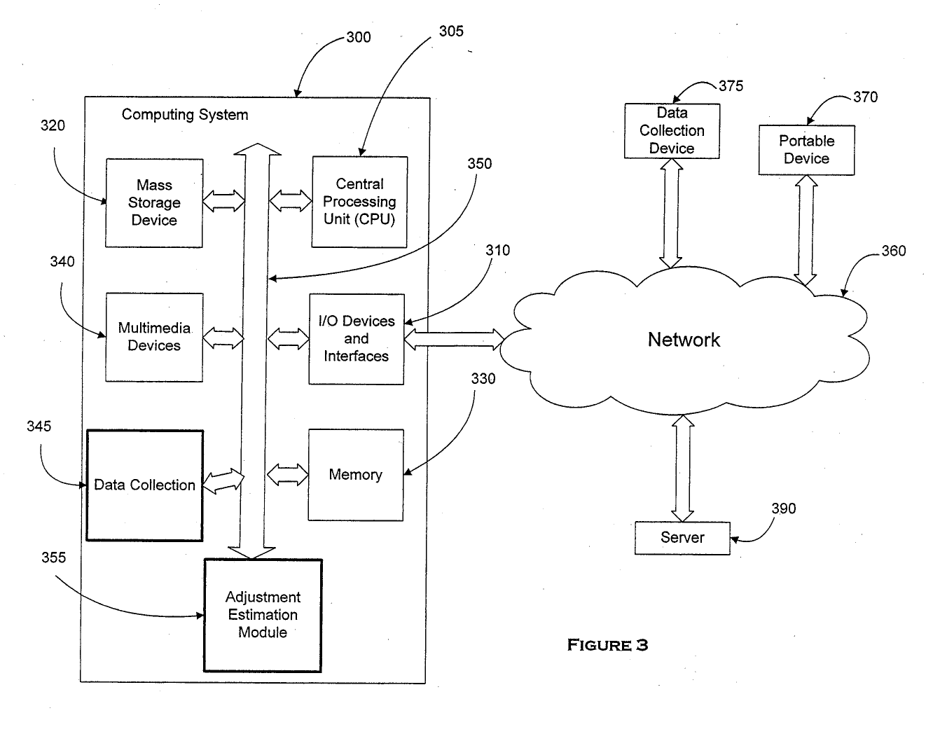

FIG. 3 is a block diagram of a computing system that may be used calculate wellhead adjustment for optimization of a total energy production in a LFG system, such as the LFG system 150 of FIG. 1.

In the embodiment of FIG. 3, the computing system 300 is in communication with a network 360 and various devices are also in communication with the network 360. As noted above, the computing system 300 may be used to implement certain systems and methods described herein. For example, in one embodiment the computing system 300 includes a data collection module 345 configured to collect and store data related to wellheads and an adjustment estimation module 355 configured to perform operations on the collected data in order to determine adjustments that may be applied to individual wellheads 110 in order to increase a total energy production for the LFG system 150. Each of these modules, as well as the other components of the computing system 300 are discussed in further detail below. The functionality provided for in the components and modules of computing system 300 may be combined into fewer components and modules or further separated into additional components and modules.

The term “module,” as used herein, means, but is not limited to, a software or hardware component, such as a field programmable gate array (FPGA) or an application specific integrated circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The computing system 300 includes, for example, a personal computer or server that is IBM, Macintosh, or Linux/Unix compatible. In one embodiment, the exemplary computing system 300 includes a central processing unit (“CPU”) 305, which may include a conventional microprocessor. The computing system 300 further includes a memory 330, such as random access memory (“RAM”) for temporary storage of information and a read only memory (“ROM”) for permanent storage of information, and a mass storage device 320, such as a hard drive, diskette, or optical media storage device. Typically, the modules of the computing system 300 are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The computing system 300 is generally controlled and coordinated by operating system software, such as the Windows 95, 98, NT, 2000, XP, Linux, SunOS, Solaris, or other compatible operating systems. In Macintosh systems, the operating system may be any available operating system, such as MAC OS X. In other embodiments, the computing system 300 may be controlled by a proprietary operating system. Conventional operating systems control and schedule computer processes for execution, perform memory management, provide file system, networking, and I/O services, and provide a user interface, such as a graphical user interface (“GUI”), among other things.

The exemplary computing system 300 includes one or more commonly available input/output (I/O) devices and interfaces 310, such as a keyboard, mouse, touchpad, and printer. In one embodiment, the I/O devices and interfaces 310 include one or more display device, such as a monitor, that allows the visual presentation of data to a user. More particularly, a display device provides for the presentation of GUIs, application software data, and multimedia presentations, for example. The computing system 300 may also include one or more multimedia devices 340, such as speakers, video cards, graphics accelerators, and microphones, for example.

In the embodiment of FIG. 3, the I/O devices and interfaces 310 provide a communication interface to various external devices. In the embodiment of FIG. 3, the computing system 300 is coupled to a network 360, such as a LAN, WAN, or the Internet, for example, via a wired, wireless, or combination of wired and wireless, communication link 315. The network 360 communicates with various computing devices and/or other electronic devices via wired or wireless communication links. In the exemplary embodiment of FIG. 3, the network 360 is coupled to a data collection device 375, such as the data collection device 120 of FIG. 1. In the embodiment of FIG. 3, the network 360 is also in communication with a portable data collection device 370, such as the GEM portable devices that are manufactured by LANDTEC in Colton, Calif., and a server 390 that may be configured to store and/or manipulate data received from the computing system 300, the data collection device 375 and/or the portable device 370. In addition to the devices that are illustrated in FIG. 3, the network 360 may communicate with other data sources or other computing devices.

In the embodiment of FIG. 3, the computing system 300 also includes two application modules that may be executed by the CPU 305. In particular, exemplary computing system 300 comprises the data collection module 345 and the adjustment estimation module 355, which are discussed in further detail below. Each of these application modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiments described herein, the computing system 300 is configured to execute the data collection module 345 and the adjustment estimation module 355, among others, in order to determine recommended adjustments to a LFG system that are intended to increase a total energy production of the LFG system. More particularly, the data collection module 345 is configured to receive data regarding characteristics of wellheads in the LFG system, such as a flow rate through each of the wellheads and a composition of the LFG. The data collection module 345 may also collect data regarding pressure, or vacuum at each of the wellheads, as well as a temperature at each of the wellheads. In addition, other characteristics of the wellheads and/or the LFG that is drawn through the wellheads may be collected by the data collection device 120.

The composition of the LFG may indicate one or more components of the gas, such as methane, oxygen, and/or nitrogen content, for example. In one embodiment, the adjustment estimation module 355 analyzes the wellhead data and provides recommended adjustments for optimizing the total energy production of the LFG system 150. In one embodiment, the energy production of a particular wellhead 110 is a function of the methane content of the LFG at the particular wellhead 110, the flow rate at the particular wellhead 110, and a time period over which the methane content and the flow rate are measured. Thus, the methane content and the flow rate may be relevant in a calculating energy production at each wellhead 110. In one embodiment, energy production is expressed in terms of British thermal units (BTUs). In other embodiments, the energy production of each wellhead comprises only an indication of the content of methane, for example, at the particular wellhead. In other embodiments, the energy production of a wellhead 110 comprises an indication of various other components of the wellhead 110, alone or in combination.

In one embodiment, optimization of energy production of the LFG system 150 comprises increasing a total energy production of the LFG system 150 to a level that is above a determined expected output level. In another embodiment, optimization of energy production of the LFG system 150 comprises maximizing a current output of methane from the LFG system 150. In other embodiments, optimization of energy production of the LFG system 150 comprises adjusting levels of other constituents of the LFG, such as nitrogen or carbon dioxide.

In one embodiment, a mathematical model is used to determine a modeled energy production for the LFG system 150 at each of a series of decomposition dates. For example, a model may indicate, based at least partly upon mass of waste in a landfill, a modeled energy production for the LFG system 150 each year over a multi-year period. In other embodiments, the model may produce monthly, weekly, or daily estimate of energy production for the LFG system 150.

One such model is the Landfill Gas Emissions Model (LandGEM) that was developed by the EPA. The LandGEM model is an automated estimation tool that can be used to estimate emission rates for total landfill gas, methane, carbon dioxide, nonmethane organic compounds, and individual air pollutants from municipal solid waste landfills. Thus, by using the LandGEM model, or other models, a modeled energy production for a landfill at any given time may be calculated. In certain embodiments described herein, the systems and methods for optimizing a total energy production of a LFG system compare a current total energy production and a modeled energy production that has been generated by one or more models, such as the LandGEM model.

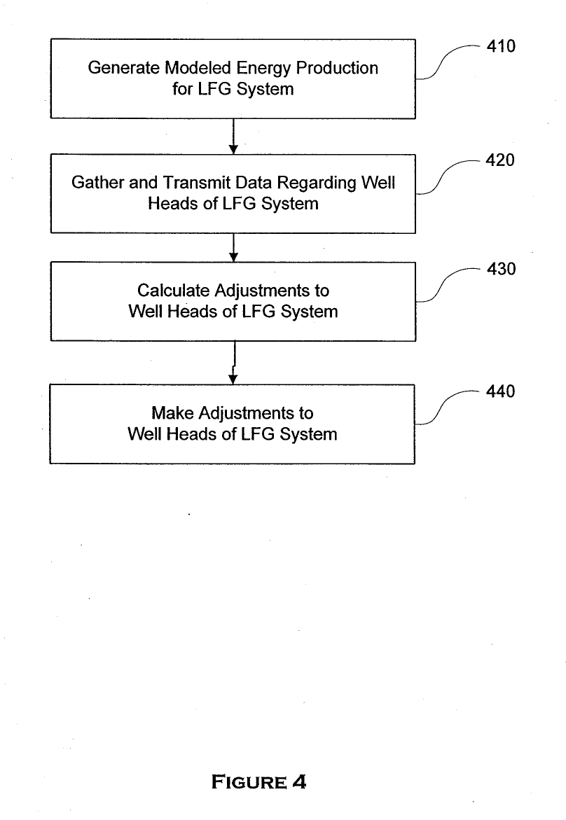

FIG. 4 is flowchart illustrating a process of optimizing a total energy production of the LFG system 150 by determining adjustments for wellheads 110 of the LFG system 150. In the embodiment of FIG. 4, the data collection module 345 (FIG. 3) collects data regarding each of the wellheads 110 in the LFG system 150, and stores the data in a location that is accessible to the adjustment estimation module 355. The adjustment estimation module 355 then analyzes the wellhead data and determines adjustments that should be made to the flow valves 210 (FIG. 2) of certain wellheads 110 in the LFG system 150 in order to increase a total energy production for the LFG system 150. Advantageously, the adjustment estimation module 355 calculates adjustments to the wellheads 110 based on the current energy production of each wellhead 110, the historical energy production of each wellhead 110, and the impact a specific adjustment to each wellhead will have on the projected total energy production of the LFG system 150. Thus, in one embodiment the adjustment estimation module 355 considers the impact that adjustment of a particular flow valve will have on not only the wellhead comprising the flow valve, but also on the entire LFG system 150. Accordingly, adjustments recommended by the adjustment estimation module 355 account for changes in vacuum that may be created by other recommended adjustments of wellheads in the same LFG system 150.

Beginning in a block 410, a model of the expected site energy output, referred to herein as a modeled energy production, is generated. As noted above, models may be used to determine an expected energy production based on one or more of a plurality of characteristics of a particular landfill. In one embodiment, the LandGEM model is used to calculate a modeled energy production for the landfill 100.

Continuing to a block 420, data from each of the wellheads 110 is collected and transmitted to the computing device 300 (FIG. 3) that will determine adjustments to certain wellheads 10 that are intended to optimize a total energy production of the LFG system 150. In one embodiment, a technician uses a portable device, such as the portable device 370 illustrated in FIG. 1, to collect data regarding each of the wellheads 110 in the landfill 100.

In one embodiment, the portable device 370 is electrically connected to each wellhead sequentially and sensors in the wellhead 110 and/or the portable device 370 detect characteristics of the wellheads 110 and of the LFG that is flowing through the wellheads 110. For example, in one embodiment the pressure of the LFG in the wellheads 110, composition of the LFG in the wellheads 110, flow rate of the LFG at the wellheads 110, and the temperature of the LFG at the wellheads 110 are determined by the portable device 370. In one embodiment, the portable device 370 is then connected to the network 360 and transmits the collected wellhead data to the computing device 300. In one embodiment, the server 390 stores a copy of the wellhead data and provides the wellhead data to authorized computing systems, such as the computing system 300, for example. In one embodiment, the portable device 370 comprises a wireless modem, or other wireless communication component, that allows the wireless device 370 to transmit wellhead data immediately after, or while, receiving the data from each wellhead 110.

In another embodiment, the wellheads 110 each comprise wireless communication components that periodically transmit wellhead data regarding characteristics of the respective wellhead. The wellhead data may be transmitted via the network 360 to the server 390 and/or to the computing system 300 for analysis. In this embodiment, a technician is not required to physically visit the landfill 100 in order to connect the portable device 370 to each of the wellheads 110 and acquire the wellhead data.

Moving to a block 430, the wellhead data is analyzed and recommended adjustments to the flow valves 210 of certain wellheads 110 are determined. As noted above, the adjustment of a single flow valve 210 may change the energy production at not only the wellhead 110 comprising the flow valve, but also to other wellheads 110 that are coupled to a common lateral line 140 or main headline 130. Thus, optimization of energy production at a single wellhead 110 may not optimize a total energy production for the entire LFG system 150. Accordingly, the adjustment estimation module 355, or other components that are configured to calculate adjustments to the wellheads, consider the projected effect of each wellhead 110 adjustment on the total energy production of the LFG system 150 when calculating suggested adjustment to the wellheads.

In one embodiment, at block 430 the adjustment estimation module 355 determine whether adjustments will maintain each wellhead and/or the entire LFG system 150 within applicable regulatory standards, such as, for example, those that are set by the EPA. Regulatory standards may set limits on LFG oxygen level, LFG temperature and the amount of vacuum that must be maintained at each wellhead, among other characteristics of wellheads and LFG. For example, regulatory standards may dictate that the oxygen content of the LFG removed by a wellhead cannot exceed 5%, the LFG temperature may not exceed 130 degrees Fahrenheit, and the wellhead must have at least some vacuum at all times. Thus, if calculated adjustments would cause a wellhead to violate regulatory standards, the adjustment estimation module 355 may adjust the recommendation further in order to place the wellhead in compliance.

Continuing to a block 440, the determined adjustments to the wellheads, and, more specifically to the flow valves of the wellheads 110, are performed on the wellheads 110. In one embodiment, the adjustment recommendations are provided to a technician who performs the adjustments by physically adjusting the flow valves of the wellheads 110 that require adjustment. In one embodiment, the adjustments indicate an expected current flow rate for the wellhead and a suggested flow for the wellhead. Thus, if a current flow rate is 20 Standard Cubic Feet per Minute (SCFM) at a particular wellhead, the adjustment estimation module 355 may determine that, in order to optimize total energy production for the LFG system 150, the flow for the particular wellhead should be increased to 22 SCFM. In one embodiment, the technician attaches the portable device 370 to the particular wellhead 110 and monitors the flow rate at the wellhead 110, while adjusting the flow adjustment valve 210 of the wellhead, until the flow rate is increased to 22 SCFM.

In one embodiment, the adjustment recommendations output by the adjustment estimation module 355 indicate a particular order in which adjustments to the wellheads 110 at the landfill 100 should be performed. As noted above, adjustment of one wellhead 110 may impact the flow of other wellheads 110. Accordingly, the flow rate at wellheads 110 prior to adjustment may have changed since the initial wellhead data was gathered from the wellhead 110, such as in block 420. This change may be due to previous adjustment of other wellheads in the LFG system 150. Accordingly, in one embodiment the adjustment recommendations anticipate changes in flow rate for a particular wellhead may be caused by previous adjustment of other wellheads, and indicate to the technician the current expected flow rate in view of previous adjustments to other wellheads 110 that will be performed prior to adjustment of the particular.

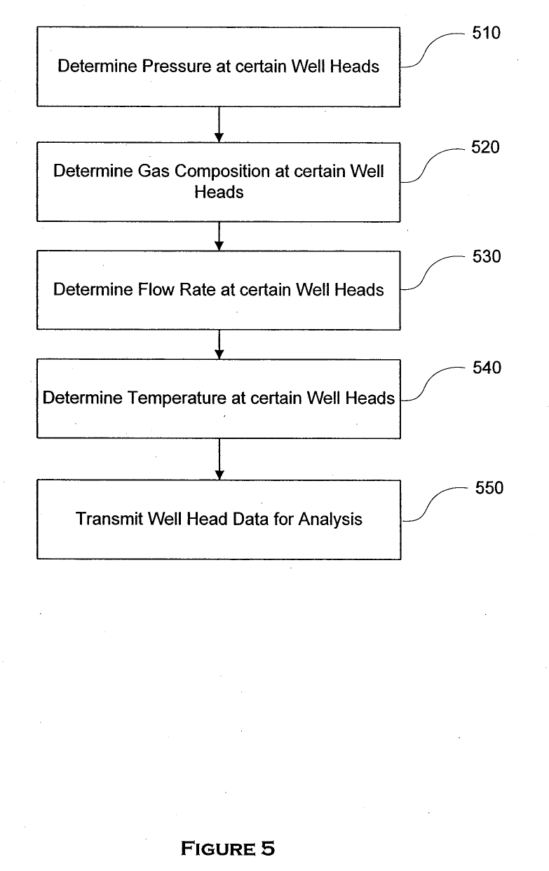

FIG. 5 is a flowchart illustrating exemplary characteristics that may be part of wellhead data that is acquired, stored, and analyzed in order to determine wellhead adjustments. As noted above, the wellhead data may analyzed by the computing system, and more specifically by a adjustment estimation module 355 of the computing system, in order to determine adjustments to flow valves of the wellheads 110 of the LFG system 150. In one embodiment, the adjustments comprise adjustments to the flow valves of particular wellheads.

Each of be characteristics outlined below in blocks 510-540 may be acquired using a portable device, such as the portable device 370 discussed above with respect to FIG. 1. In one embodiment, a technician connects the portable device 370 to each of the wellheads 110 in a LFG system 150. The portable device 370 determines certain characteristics of the wellhead 110 and/or the passing through the wellhead 110. As noted above, the portable device 370 may communicate the wellhead data to the server 390/or to the computing system 300 via one or more wired and/or wired communication networks and using any available communication protocols. For example, in one embodiment the portable device 370 comprises a wireless modem that transmits the wellhead characteristics to the computing device via network connection, where the wellhead data is transmitted to the computing device 300 after the characteristics are determined at each wellhead 110. In this embodiment, the computing system 300 receives the wellhead data as the technician moves from one wellhead 110 to another in the LFG system 150. Accordingly, the computing system 300 may determine recommended adjustments to wellheads 110 at the landfill 100 as soon as the technician has retrieved characteristics from each of a wellheads. In this embodiment, the computing system 300 may being calculating adjustments even before wellhead data has been received from each of the wellheads. In another embodiment, the technician uploads the wellhead data from all of the wellheads 110 to the portable device 370 and subsequently connects the portable device 370 to a wired network 360, or directly to the computing system 300, in order to transmit the wellhead data to the computing system 300. In yet another embodiment, each of the wellheads 110 comprises wireless communication components configured to transmit the wellhead data to the computing system 300 via one or more wireless and/or wired networks.

In one embodiment, the wellhead data for each wellhead 110 of the LFG system 150 is determined, such as by using sensors in wellhead 110 and/or in the portable device 370. In other embodiments, only selected wellheads 110 are accessed by the portable device 370 in order to determine characteristics of the wellheads 110.

In a block 510, pressure at certain wellheads is determined. As noted above, in one embodiment a portable device 370 is electrically coupled to a wellhead 110 in order to determine a pressure of the LFG that flows through the wellhead 110. Thus, in block 510, a portable device 370 may be used to determine pressure at certain wellheads 110. As those of skill in the art will recognize, the pressure characteristics of a wellhead 110 are directly related to vacuum characteristics of that wellhead 110. Thus, in block 510, an amount of vacuum applied to a wellhead 110 may be determined and stored for later analysis.

In a block 520, a composition of the gas flowing through certain wellheads 110 is determined. For example, a methane, oxygen, and/or nitrogen content of the LFG at the particular wellhead is determined. In certain embodiments, other component characteristics of the LFG may also be determined. Sensors and equipment for determining the composition of gases are known in the art. Any suitable sensors or equipment may be implemented in the wellheads 110 and/or the portable device 370 that is coupled to the wellheads 110 in order to determine the gas in order to determine the wellhead 110 LFG composition.

In a block 530, a flow rate of certain wellheads 110 is determined. For example, the portable device 370 may a flow rate of the through the 110 in standard cubic feet per minute (SCFM). In other embodiments, the flow rate may be determined in other units. Sensors and equipment for determining the flow rate of gases are known. Any suitable sensors or equipment may be implemented in the wellheads 110 and/or the portable device 370 in order to determine the flow rate of LFG through the wellheads 110.

In a block 540, a temperature of the LFG at certain wellheads 110 is determined. For example, the portable device 370 may receive a temperature reading from a wellhead 100 to which the portable device 370 has been coupled. In another embodiment the portable device 370 may be configured to receive a sample of the LFG in the wellhead 110 and determine a temperature of the LFG using sensors in the portable device 370.

Continuing to a block 550, the wellhead data is transmitted to the computing device 300. As noted above, in one embodiment the data collection module 345 collects the data from the portable device 370, or from the alternative sources of wellhead data. In one embodiment, the wellhead data from the portable device 370 is transmitted to the server 390 and is then accessed by the data collection module 345.

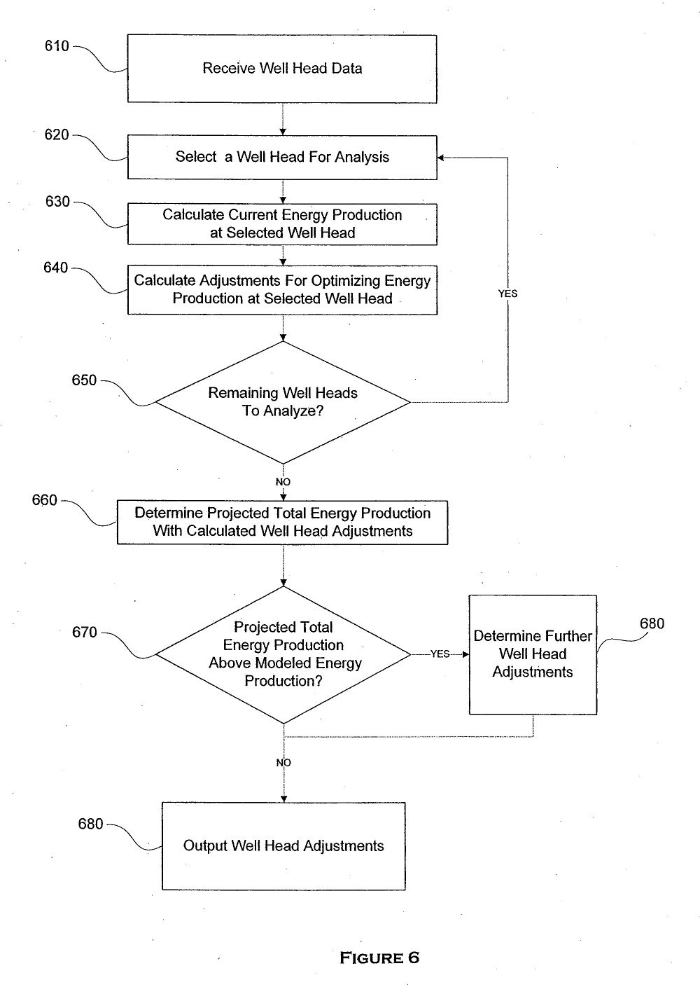

FIG. 6 is a flowchart illustrating an exemplary method of determining adjustments for individual wellheads 110 of the LFG system 150. As noted above, adjustments to the flow valves 120 of wellheads 110 may significantly increase a methane production and a corresponding energy production of a LFG system 150. However, because adjustments to each individual wellhead 110 may effect the flow and methane production of other wellheads 110, adjustment of flow valves should be determined based not only on the effect on the particular wellhead, but also based on the effect adjustment of a particular wellhead will have on the total energy production of the LFG system 150.

Beginning in a block 610, the wellhead data is received by the computing system 300. As discussed above with respect to FIG. 5, the wellhead data may include multiple characteristics of regarding the wellheads 110 and/or regarding the LFG that is flowing through the wellheads. In one embodiment, the data received by the computing system 300 includes a data for each of the wellheads 110. For example, in one embodiment flow, composition, and pressure data for each wellhead 110 in the LFG system 150 are received.

Blocks 620-650 comprise a series of actions that are performed on data for each wellhead 110. Thus, the actions of blocks 620-640 are performed with respect to each wellhead 110 for which wellhead data has been received. In one embodiment, blocks 620-640 are performed on data for every wellhead 110 of the LFG system 150, while in other embodiments, blocks 620-640 are performed on only a portion of the wellhead data.

In a block 620, data for a particular wellhead is selected for analysis. In one embodiment, the method selects wellhead data starting with a wellhead at one end of the main header line 130 and moving towards the other end of the main header line 130, selecting the wellheads 110 along lateral lines 140 according to their position along the main header line 130. For example, with reference to FIG. 1, data for wellhead 110A may be initially selected for analysis at block 620. Subsequent executions of block 620 may selected data for other wellheads in the order 110B, 110C, 110D, 110E, 110G, etc., for example. In other embodiments, the order of selecting wellheads for analysis may be different that the order described above. In addition, in one embodiment not all of the wellheads 110 are selected for analysis.

Continuing to a block 630, a current energy production at the selected wellhead is determined. In one embodiment, the current energy production for a wellhead 110 is a component of both a methane quality and the flow rate at the wellhead. Thus, in this embodiment, the LFG methane content and the flow rate information in the data related to the selected wellhead 110 are accessed in order to determine a energy production at the selected wellhead. In one embodiment, the energy production calculation also includes a temporal factor, indicating a time period over which the methane content and the flow rate were acquired. In other embodiments, other characteristics of the selected wellhead 110 are analyzed in order to determine an energy production for the wellhead 110. In one embodiment, the energy production is directly related to methane production at the selected wellhead 110.

Moving to a block 640, adjustments for optimizing energy production at the selected wellhead 110 are determined. In one embodiment, historical data regarding the energy production of the selected wellhead 110 are accessed in order to determine if the current energy production at the selected wellhead 110 is consistent with the historical trend. In one embodiment, previous adjustments to the wellhead 110 are also accessed. In one embodiment, the historical wellhead 110 energy production data and the previous adjustment data for the selected wellhead 110 are used to determine if the flow valve of the selected wellhead 110 should be adjusted to increase flow, decrease flow, or if the flow valve for the selected wellhead 110 should not be adjusted.

For example, if the energy production at a selected wellhead 110 has increases by an average of about 0.5% per month over the previous 8 months, the wellhead 110 may be expected to continue increasing production at similar rates. Thus, if the selected wellhead 110 has been adjusted each of the previous 8 months to increase flow through the wellhead by about 1% per month, the adjustment estimation module 355 may determine that a similar adjustment to the selected wellhead 110 should again be made in order to further increase energy production. However, if the current data for the selected wellhead 110 indicates that energy production at the selected wellhead 110 has decreased over the previous month (or other measurement period), the adjustment estimation module 355 may determine at block 640 that the flow valve of the selected wellhead 110 should not be opened further and, possibly should be moved to decrease flow through the selected wellhead 110. Thus, the adjustment estimation module 355 determines based on the historical data from the selected wellhead 110 and the current data from the wellhead, how energy production at the selected wellhead 110 may be increased.

In other embodiments, the adjustment estimation module determines adjustments to the wellhead 110 using the production model for the LFG system 150. For example, a total energy production for a LFG system 150 may be divided into an expected energy production for each of the wellheads 110. Thus, the adjustment estimation module 355 may calculate adjustments to the selected wellhead 110 that are expected to adjust the energy production at the selected wellhead 110 to the modeled energy production for the wellhead 110. In this way, the adjustment estimation module may anticipate increase and/or decrease in the expected energy production of the LFG system 150 and of individual wellheads 110 based on the generated model prior and make adjustments to the wellheads 110 in order to track the model.

Moving to a decision block 650, the adjustment estimation module 355 determines if additional wellheads 110 need to be analyzed. In one embodiment, each of the wellheads 110 are analyzed and suggestions for adjusting flow valves of the wellheads 110 are provided at block 640. Thus, with reference to FIG. 1, for example, the method returns to block 620 until wellhead 110N is the selected wellhead. Accordingly, for each wellhead in the LFG system 150, the current data for the wellheads has been analyzed and an adjustment for each wellhead 150 has been calculated (block 640). In one embodiment, recommended adjustments to wellheads 150 may indicated that a flow valve should be further opened, further closed, or not adjusted. In one embodiment, the adjustments are delivered to the technician in terms of a flow rate adjustment so that the technician monitors the flow rate of a wellhead as the flow valve is adjusted until the indicated flow rate is achieved.

Next, in a block 660, a projected total energy for the LFG system 150 is determined using the estimated energy production of the wellheads 110 after they are adjusted using the adjustments calculated in block 640. Thus, the total energy production determined in block 660 reflects the adjustments to the wellheads that are calculated in block 640. Advantageously, although the wellhead adjustments have not yet been made to the wellheads 110 at the landfill 100, the computing system 300 calculates how the series of recommended adjustments for each wellhead 110 will affect the total energy production of the LFG system 150. In one embodiment, the projected energy production for each the individual wellheads 10, after adjustment according to the suggested adjustments calculated in block 640, are summed in order to determine a projected total energy production from the LFG system 150.

Next, in a block 670, the projected total energy production is compared with a modeled energy production for the landfill 100. If the projected total energy production is less than the modeled energy production then the method moves to a block 680 where additional adjustments for certain wellheads are determined. If, however, the projected total energy production is greater than or equal to the modeled energy production, the method continues to a block 680 where the calculated adjustments for each wellhead are provided to a technician.

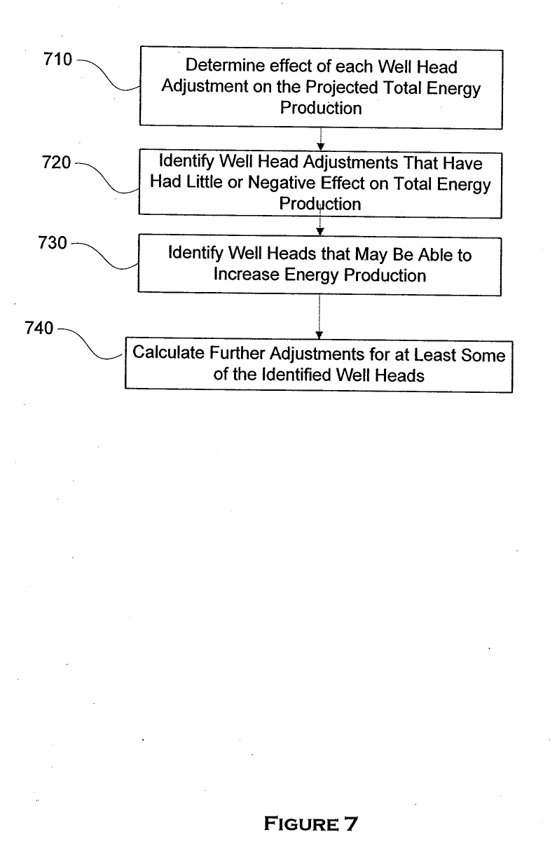

In a block 680, additional adjustments to certain wellheads 110 are determined in order to further optimize the projected total energy production of the LFG system 150 to at least the modeled energy production. The additional adjustments may analyze a number of aspects of the wellheads 110 and of the LFG system 150 in order to recommend additional adjustments that may increase the total energy production. For example, if a flow valve of a particular wellhead was previously adjusted to increase flow and the energy production of the wellhead did not correspondingly increase, the particular wellhead may be adjusted to decrease flow. In one embodiment, if the flow rate at one wellhead is decreased, additional vacuum and, thus, a higher flow rate, may be possible for other higher producing wellheads. Additionally, a number of further adjustments may be determined at block 680, several of which are described in further detail with respect to FIG. 7.

At a block 680, the recommended wellhead adjustments are output from the computing device 300 and made available for implementation. In the exemplary embodiment of FIG. 6, the wellhead adjustments are indicative of either the adjustment calculated in block 640 or of the additional adjustments calculated in block 680, as well as the adjustments calculated in block 640. In one embodiment, the computing system 300 communicates the wellhead adjustments to the portable device 370 via a wireless communication link. In another embodiment, the adjustments are uploaded to a portable device 370 that is connected to the computing system 300 via a wired network connection. In yet another embodiment, the adjustments may be printed at the computing system 300 and then reviewed by a technician in order to make the adjustments. In one embodiment, the adjustments are transmitted to the server 390 and are accessed by a technician, such as by using a portable device 370.

FIG. 7 is a flowchart illustrating exemplary methods for calculating additional wellhead adjustments, such as might be calculated in block 680 of FIG. 6, in order to further optimize a projected total energy production for the LFG system 150. The exemplary methods of FIG. 7 may be stored as processes accessible by the adjustment estimation module 355 and/or other components of the computing system 300. In various embodiments, combinations of the blocks described with respect to FIG. 7 are performed on the wellhead data in order to determine further optimizations for total energy production of the LFG system 150.

In a block 710, the effect of each calculated wellhead adjustment (block 640 of FIG. 6) on the projected total energy is determined. For example, in one embodiment a percentage of a increased total energy production that is expected (after adjustment of wellheads 110 according to the calculated adjustments in block 640) is determined for each wellhead. Thus, each wellhead may be analyzed with respect to its affect on the total energy production, rather than just the energy production of the individual wellhead. In one embodiment, an adjustment to a wellhead may increase the energy production of the particular wellhead significantly, but may not have a significant impact on the total energy production. For example, if a LFG system comprises 100 wellheads, it may be expected that each wellhead provide 1% of the total energy. Proportional distribution of the energy production is used for purposes of illustration. Those of skill in the art will recognize that the distribution of energy production may not be proportional but may be dependent on several factors of each individual wellhead, such as the location of the wellhead in the landfill. In the embodiment where a particular wellhead is expected to contribute 1% of the total energy, even if a projected increase in energy for the particular wellhead is large, the affect of the adjustment on the wellhead to the total energy may not be significant. Thus, be analyzing the effect each adjustment has on the total energy for the LFG system 100, the computing system 300 may determine wellheads that are not contributing their allotted share to the total energy.

In a block 720, wellhead adjustments that have little or negative effect on the projected total energy are identified. For example, historical data for a particular wellhead may be analyzed in order to identify wellheads that have not increases energy production proportionally to increases in flow through the particular wellhead. For these wellheads, further adjustments further increasing flow through the particular wellhead will likely not increase the energy production of the wellhead to a proportional level to the total increases in flow. However, additional increases may cause overpulling of the wellhead, which could introduce oxygen into the wellhead, decrease bacteria production in the area surrounding the wellhead, and increase a risk of fire igniting within the wellhead. Thus, for the wellheads that are identified as not providing energy increases that are proportional to increases in flow applied to the respective wellheads, further adjustments may be calculated at block 680 indicating that flow to the wellheads should be decreases or maintained at the current level.

In a block 730, wellheads that may be able to provide further produce additional energy by increasing flow beyond the calculated adjustment in block 640, for example, are identified. These identified wellheads may be further adjusted beyond the adjustments calculated in block 640, for example, in order to increase the total energy of the LFG site 150 upwards toward the modeled energy.

In a block 740, further adjustments for at least some of the identified wellheads are calculated. For example, further adjustments for some of the wellheads identified in block 720 as not providing an increase in energy that is proportional to flow rate increases, or wellheads that have actually decreased in energy as their flow rates have been increased, may indicate that the flow rate of these wellheads is decreased. Conversely, further adjustments for some of the wellheads identified in block 730 as potentially being able to produce additional energy may indicate that the flow rate of these wellheads is increased. In one embodiment, in block 740 the flow rate of certain wellheads is accelerated, while in block 640 of FIG. 6 the flow rate adjustments for the same wellheads are only calculated to maintain an energy increase at a steady level. Thus, the adjustments calculated in block 740 may accelerate the energy of certain wellheads beyond the expected energy production for the wellheads based on the modeled energy. In other embodiments, further adjustments to wellheads are calculated based on additional historical and current data for the wellheads and for the LFG system 150.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of optimizing energy production of a landfill gas extraction system positioned at a landfill site, the landfill gas extraction system comprising a plurality of wellheads positioned around the landfill configured to extract landfill gas from the landfill, wherein each of the wellheads comprises a flow valve configured to control an amount of flow through the wellhead into the landfill gas extraction system, the method comprising:
(a) receiving data regarding characteristics of at least some of the wellheads;
(b) determining adjustments to flow valves of at least some of the wellheads in order to optimize energy production at the wellheads; and
(c) determining further adjustments to the flow valves of at least some of the wellheads in order to optimize a total energy production of the landfill gas extraction system, wherein the further adjustments indicate that flow to certain wellheads should be decreased below levels indicated by the determined adjustments and flow to other wellheads should be further increased above levels indicated by the determined adjustments.

2. The method of claim 1, further comprising generating a projected energy production for the landfill gas extraction system, wherein the further adjustments are determined to adjust a total energy production of the landfill gas extraction system to about the projected energy production.

3. The method of claim 1, wherein the characteristics comprise at least one of flow through the wellhead, methane content in the land fill gas passing through the wellhead, and temperature of the landfill gas passing through the wellhead.

4. The method of claim 1, wherein the determining adjustments to flow valves comprises analyzing historical energy production at a particular wellhead.

5. The method of claim 4, wherein a current energy production for individual wellheads is determined based on the received data regarding characteristics of the respective wellheads.

6. The method of claim 4, wherein the determining further adjustments comprises identifying one or more wellheads for which the current energy production of the one or more wellheads is less than a projected energy production for the respective wellheads in response to previous adjustments to the flow valves of the one or more wellheads.

7. The method of claim 6, wherein the determining further adjustments determines that the flow valves of the identified one or more wellheads should be adjusted to decrease flow through the identified one or more wellheads.

8. The method of claim 4, wherein the determining further adjustments comprises identifying one or more wellheads for which the current energy production of the one or more wellheads is more than a projected energy production for the respective wellheads in response to previous adjustments to the flow valves of the one or more wellheads.

9. The method of claim 8, wherein the determining further adjustments determines that the flow valves of the identified one or more wellheads should be adjusted to increase flow through the identified one or more wellheads.

10. A system for optimizing energy production of a landfill gas extraction system positioned at a landfill site, the landfill gas extraction system comprising a plurality of wellheads positioned around the landfill configured to extract landfill gas from the landfill, wherein each of the wellheads comprises a flow valve configured to control an amount of landfill gas that flows through the respective wellhead into the landfill gas extraction system, the method comprising:
means for receiving data regarding characteristics of at least some of the wellheads;
means for determining adjustments to flow valves of at least some of the wellheads in order to optimize energy production at the wellheads; and
means for determining further adjustments to the flow valves of at least some of the wellheads in order to optimize a total energy production of the landfill gas extraction system, wherein the further adjustments indicate that flow to certain wellheads should be decreased and flow to other wellheads should be further increased.

11. The system of claim 10, wherein a computing system comprises the means for receiving data characteristics, the means for determining adjustments, and the means for determining further adjustments.

12. A computer system for determining recommended adjustments to flow rates of at last some of a plurality of wellheads positioned at a landfill, the system comprising:
a data collection module adapted to receive data regarding characteristics of the wellheads at the landfill, wherein the characteristics are usable to determine a current energy production for the wellheads, the data collection module also receives historical data for the wellheads, the historical data including historical energy production data and historical flow rate data regarding respective wellheads;
an adjustment recommendation module adapted to determine suggested adjustments to the flow rates of at least some of the wellheads, wherein the suggested adjustments for a respective wellhead is determined based at least partly on the current energy production of the respective wellhead, the historical data for the respective wellhead, and an affect a preliminary suggested adjustment would have on a total energy production of the plurality of wellheads.

13. The system of claim 12, wherein the preliminary suggested adjustment for a respective wellhead indicates adjustments to the respective wellhead that will increase energy production at the respective wellhead.

14. The system of claim 12, wherein the suggested adjustments are transmitted to a mobile device positioned near the plurality of wellheads.

15. A computing system for determining adjustments for each of a plurality of wellheads in a gas extraction system in order to increase a total energy production of the gas extraction system to at least an expected total energy production, the computing system determining preliminary adjustments for each of the wellheads and then determining further adjustments to certain of the wellheads based at least partly on a current energy production of respective wellheads, data regarding historical energy production of respective wellheads, and an affect the preliminary adjustment for a respective wellhead would have on the total energy production of the gas extraction system.

16. The computing system of claim 15, wherein the determined adjustment for a respective wellhead indicates a flow rate for the respective wellhead.

17. The computing system of claim 15, wherein the computing system determines a historical flow rate trend for each wellhead in order to calculate the preliminary adjustments for each respective wellhead such that the preliminary adjustments maintain the historical flow rate trend for each respective wellhead.

18. The computing system of claim 17, wherein the computing system determines one or more wellheads for which a current energy production is greater than an expected energy production projected for the respective one or more wellheads, wherein the further adjustments indicate that a flow rate of the one or more wellheads indicate that the flow rate for the one or more wellheads should be increased so that the flow rate of these wellheads increases above the historical flow rate trend.

19. The computing system of claim 16, wherein the determined further adjustment for at least one wellhead indicates a decrease in flow rate below the determined adjustment for the at least one wellhead.

20. The computing system of claim 16, wherein the determined further adjustment for at least one wellhead indicates an increase in flow rate above the determined adjustment for the at least one wellhead.
